(19) United States
(12) Patent Application Publication
(10) Pub. No.: US 2005/0022435 A1
(43) Pub. Date: Feb. 3, 2005

(54) Camcorder with decorative sealed vessel

(76) Inventor: Vincent K. Lee, Taipei (TW)

Correspondence Address: BACON & THOMAS, PLLC, 625 SLATERS LANE, FOURTH FLOOR, ALEXANDRIA, VA, 22314, US

(21) Appl. No.: 10/845,239

(22) Filed: May 14, 2004

(30) Foreign Application Priority Data
Jul. 30, 2003 (TW) 092213869

(51) Int. Cl. G09F 19/00

(52) U.S. Cl. 40/426

(57) ABSTRACT

The present invention discloses a festive camcorder comprising a camcorder and a decorative sealed vessel. The decorative sealed vessel is coupled to the main base of the camcorder. The decorative sealed vessel has at least one liquid type and a decorative structure.

### BACKGROUND OF THE INVENTION

1. Field of the Invention

The present invention relates to a camcorder with a decorative sealed vessel, and more particularly, to a small sized camcorder with a decorative sealed vessel.

2. Description of the Related Art

Several patents have been granted regarding the combination of a decorative sealed vessel with other objects to create a decorative effect; for example, in U.S. Pat. No. 6,380,926 several embodiments are disclosed, such as a cup having with a decorative sealed vessel, or a toothbrush box with a decorative sealed vessel.

However, no prior art discloses a camcorder with a decorative sealed vessel. Camcorders have been in use for over 20 years, and have become a necessary device for many people. Many design shapes for camcorders are developed each year, but none of the designs contain decorative sealed vessels.

Small sized camcorders, such as a PC camera (or a web camera), are increasingly popular; they are usually placed next to a display, but are infrequently used, unlike the display or a mouse. Therefore, finding a way to increase the functionality of the camcorder is desirable, for example, by adding a decorative element to the camera.

### SUMMARY OF THE INVENTION

A main objective of the present invention is to provide a camcorder with a decorative sealed vessel, which causes the camcorder to be more enjoyable and interesting.

Another objective of the present invention is to provide a camcorder with a decorative sealed vessel, which has a decorative sealed vessel capable of moving automatically.

In order to achieve the above mentioned objectives, the present invention comprises a camcorder and a decorative sealed vessel. The decorative sealed vessel is coupled to a main base of the camcorder. The decorative sealed vessel has at least one type of liquid and a decorative structure. The camcorder further comprises a first magnet and an electric motor.

In order to cause the decorative sealed vessel to move automatically, a second magnet is mounted on the decorative structure, so that when a base of the camcorder provides a varying magnetic field, the decorative structure moves accordingly. The varying magnetic field can be provided by the electric motor or by an electromagnet.

Other objects, advantages, and novel features of the invention will become more apparent from the following detailed description when taken in conjunction with the accompanying drawings.

### BRIEF DESCRIPTION OF THE DRAWINGS

FIG. 1 illustrates a first embodiment according to the present invention.

FIG. 2 is a perspective view of a second embodiment according to the present invention.

FIG. 3 is a side view of the second embodiment according to the present invention.

FIG. 4 illustrates a third embodiment according to the present invention, and includes a partial cross-sectional drawing.

FIG. 5 is a side view of an electric motor shown in FIG. 4 according to the present invention.

FIG. 6 illustrates a fourth embodiment according to the present invention, and includes a partial cross-sectional drawing.

### DETAILED DESCRIPTION OF THE PREFERRED EMBODIMENT

Four embodiments are described in the following description.

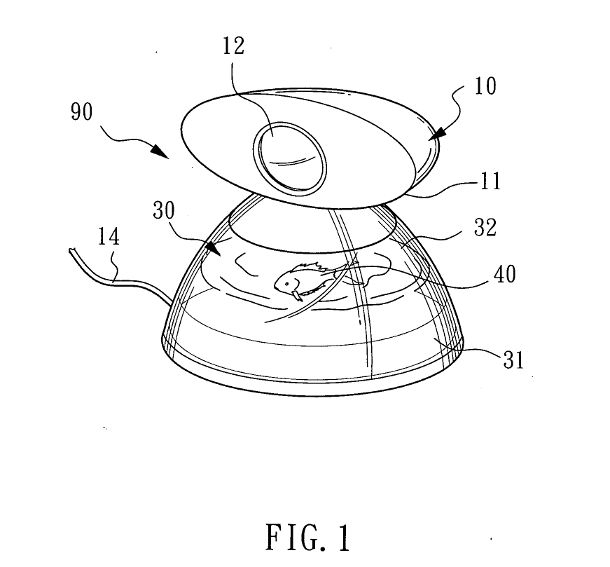

Please refer to FIG. 1. FIG. 1 illustrates a first embodiment according to the present invention. A camcorder with a decorative sealed vessel 90 comprises a camcorder 10 and a sealed vessel 30.

The camcorder 10 comprises a lens 12 and a base 11. Circuitry (not shown) is installed in the base 11 to provide the photographic functionality of the camcorder 10. The base 11 may have several different parts, and some parts may rotate with the leans 12. The camcorder 10 can be a PC camera (web camera) or a monitor camera, which is basically a small sized camera. Most PC cameras require an external power source, which is achieved by utilizing a cable 14 (with a USB interface) to connect to a computer. The present invention can also be applied to a wireless camera, which has its own power source, such as a battery (not shown) in the base 11. However, since the camcorder 10 is a very common product and not the key point of the present invention, no additional description is required.

The decorative sealed vessel 30 is combined with the base 111 of the camcorder 10. The decorative sealed vessel 30 comprises at least one type of liquid and a decorative structure 40. According to the embodiment, there are two types of liquids: a first liquid 31 and a second liquid 32. The second liquid 32 is less dense than the first liquid 31, and they usually have different colors. The decorative structure 40 is insoluble and floats between the first liquid 31 and the second liquid 32. Many methods may be used to combine the decorative sealed vessel 30 with the base 111, including the use of adhesives or clamps.

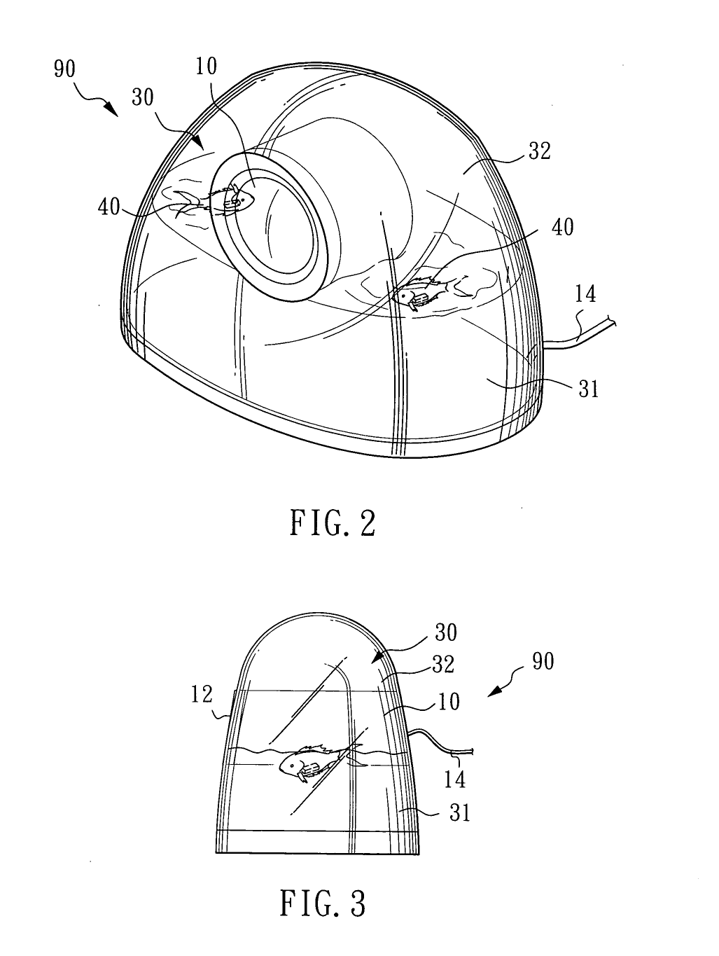

Please refer to FIG. 2 and FIG. 3. FIG. 2 is a perspective view of a second embodiment according to the present invention. FIG. 3 is a side view of the second embodiment according to the present invention. In the second embodiment, the decorative sealed vessel 30 is not necessarily below the base 11. As shown in FIG. 2, the camcorder 10 appears to be embedded in the decorative sealed vessel 30, which provides a more interesting appearance.

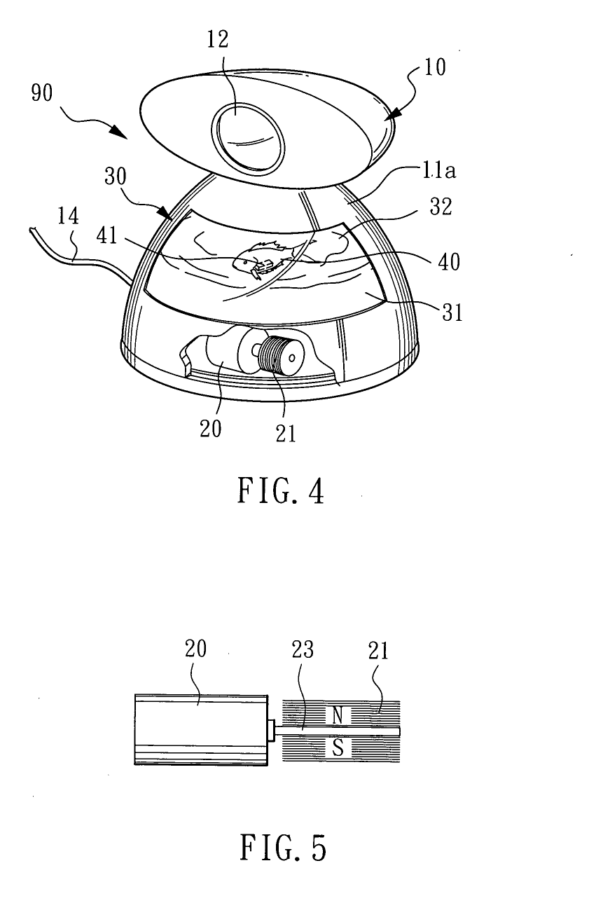

Please refer to FIG. 4. FIG. 4 illustrates a third embodiment according to the present invention, and includes a partial cross-sectional drawing. In this embodiment, an electric motor 20 is installed below the base 11a. The electric motor 20 may be any device that converts electrical power to mechanical power. For example, the electric motor 20 may be a common rotational-style motor, a motor for a clock, a solenoid, etc. The electric motor 20 receives electrical power from the cable 14, or from a battery in the base 11a. Please refer to FIG. 5. FIG. 5 is a side view of the electric motor shown in FIG. 4 according to the present invention. A first magnet 21 is mounted on a shaft 23 (which is a transfer means) of the electric motor 20. Thus, the electric motor 20 rotates the first magnet 21 to generate a varying magnetic field. Many different mechanical designs may be employed to move the first magnet 21 in order to generate a varying magnetic field. The manner of moving the first magnet 21 could be actual rotation as mentioned above, or could also be an oscillatory movement, vibration, or other types of movement. The transfer means between the electric motor 20 and the first magnet 21 may be the shaft 23, but may also include gears, linkages, etc. Therefore, it is not necessary that the electric motor 20 and the first magnet 21 be directly connected, but simply that the electric motor 20 provides power to move the first magnet 21.

In this embodiment, a second magnet 41 is mounted on the decorative structure 40. The first magnet 21 is positioned around the decorative sealed vessel 30. Consequently, when the first magnet 21 moves, the second magnet 41 also moves, causing the decorative structure 40 to move accordingly. Because of the characteristics of the varying magnetic field and the liquid, the decorative structure 40, in fact, will tend to make unpredictable movements (shaking), and the first liquid 31 and the second liquid 32 will also shake accordingly.

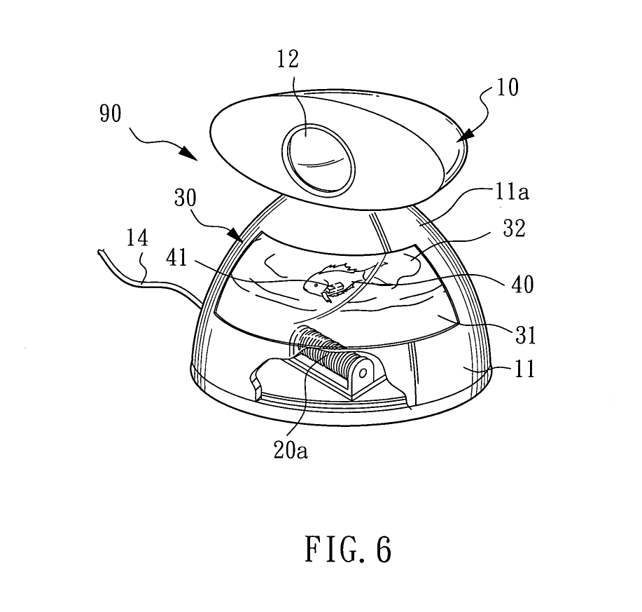

Please refer to FIG. 6. FIG. 6 illustrates a fourth embodiment according to the present invention, and includes a partial cross-sectional drawing. The major difference of the fourth embodiment is the use of an electromagnet 20a, instead of using the first magnet 21 and the electric motor 20 shown in the first embodiment. The electromagnet 20a is a standard electronics component, which generates a magnetic field when an electric current is provided (i.e. when the electric current passes through a coil, an electromagnet's major element, a magnetic field is generated). Therefore, it is easy to make the electromagnet 20a generate a varying magnetic field by providing the electromagnet 20a with a correspondingly varying electric current. For example, by changing the amount of current, or the direction of the current, a varying electric current is produced.

In the third and fourth embodiments, the electrical power is provided to the electric motor 20 or the electromagnet 20a to generate a varying magnetic field, as mentioned above. The electric current provided to the electric motor 20 or the electromagnet 20a can be continuous, discontinuous, or provided under other pre-set conditions.

Although the present invention has been explained in relation to its preferred embodiment, it is to be understood that many other possible modifications and variations can be made without departing from the spirit and scope of the invention as hereinafter claimed.

1. A camcorder with a decorative sealed vessel comprising:
a camcorder comprising a lens and a base; and
a decorative sealed vessel comprising at least one type of liquid and at least one decorative structure being insoluble in the liquid;
wherein the decorative sealed vessel is coupled with the base of the camcorder.

2. The camcorder with a decorative sealed vessel as claimed in claim 1, wherein the decorative sealed vessel is below the base.

3. The camcorder with a decorative sealed vessel as claimed in claim 1, wherein the camcorder further comprises:
a first magnet;
an electric motor for converting electrical power to mechanical power so as to move the first magnet; and
the decorative structure further comprising a second magnetic;
wherein the first magnet is positioned around the decorative sealed vessel, and when the first magnet moves, the second magnet moves with the first magnet so that the decorative structure also moves accordingly.

4. The camcorder with a decorative sealed vessel as claimed in claim 1, wherein the camcorder further comprises:
an electromagnet for generating a varying magnetic field; and
the decorative structure further comprises a second magnet;
wherein the electromagnet is positioned around the decorative sealed vessel, and when the electromagnet generates a varying magnetic field, the second magnet moves so that the decorative structure also moves accordingly.
